(19) United States
(12) Patent Application Publication
(10) Pub. No.: US 2021/0052461 A1
(43) Pub. Date: Feb. 25, 2021

(54) DISEASE-BASED CONFIGURATIONS IN A HIGH-FREQUENCY CHEST WALL OSCILLATION DEVICE

(71) Applicant: Hill-Rom Services PTE. LTD., Singapore (SG)

(72) Inventors: Deny D. Barilea, Singapore (SG); Shadakshari D. Chikkanaravangala, Singapore (SG); Kok Boon R. Ong, Singapore (SG); Susan E. Malaret, Chanhassen, MN (US)

(21) Appl. No.: 16/941,618

(22) Filed: Jul. 29, 2020

Related U.S. Application Data
(60) Provisional application No. 62/889,205, filed on Aug. 20, 2019.

(51) Int. Cl. A61H 9/00

(52) U.S. Cl. CPC A61H 9/0071; A61H 9/0007; A61H 2205/084; A61H 2201/1238; A61H 2201/5046; A61H 2201/1619; A61H 2201/5043

(57) ABSTRACT

A high frequency chest wall oscillation apparatus includes an air pulse generator carried by a housing. Circuitry is carried by the housing and configured to control the air pulse generator. A control panel is carried by the housing and coupled to the circuitry. The control panel permits a user to select first and second respiratory ailments to be treated by application of pressure pulses from the air pulse generator to a chest of a patient.

### CROSS-REFERENCE TO RELATED APPLICATIONS

This application claims priority under 35 U.S.C. § 119(e) to U.S. Provisional Patent Application Ser. No. 62/889,205, filed Aug. 20, 2019, which is expressly incorporated by reference herein.

### BACKGROUND

The present disclosure relates generally to high frequency chest wall oscillation (HFCWO) therapy systems, and more particularly, to HFCWO therapy systems suitable for use in a hospital or healthcare facility.

Manual percussion techniques of chest physiotherapy have been used for a variety of diseases, such as cystic fibrosis, emphysema, asthma and chronic bronchitis, to remove excess mucus that collects in the lungs. To bypass dependency on a caregiver to provide this therapy, chest wall oscillation devices have been developed to deliver HFCWO therapy to a patient. U.S. Pat. No. 7,615,017 discloses an illustrative HFCWO therapy system, which is hereby incorporated by reference herein.

### SUMMARY

The present disclosure includes one or more of the features recited in the appended claims and/or the following features which, alone or in any combination, may comprise patentable subject matter.

According to an aspect of the disclosed embodiments, a high frequency chest wall oscillation apparatus may include a housing. An air pulse generator may be carried by the housing. Circuitry may be carried by the housing and may be configured to control the air pulse generator. A control panel may be carried by the housing and may be coupled to the circuitry. The control panel may permit a user to select first and second respiratory ailments to be treated by application of pressure pulses from the air pulse generator to a chest of a patient. A first range of selectable baseline pressures of the pressure pulses for the first respiratory ailment may be different than a second range of selectable baseline pressures of the pressure pulses for the second respiratory ailment.

In some embodiments, the control panel may include a display screen with selectable buttons adjacent to the display screen. The control panel may include a touchscreen display.

Optionally, the first respiratory ailment may be cystic fibrosis. The second respiratory ailment may be one of bronchiectasis or a neuromuscular ailment.

It may be desired that the first range of selectable baseline pressures may have a maximum baseline pressure greater than a maximum baseline pressure of the second range of selectable baseline pressures. The first range of selectable baseline pressures may have a minimum baseline pressure greater than a minimum baseline pressure of the second range of selectable baseline pressures. A mean baseline pressure of the first range of selectable baseline pressures may be more than half of a mean baseline pressure of the second range of selectable baseline pressures. The mean baseline pressure of the first range of selectable baseline pressures may be at least one kPA greater than the mean baseline pressure of the second range of selectable baseline pressures. The first range of selectable baseline pressures may be between 2 kPa and 4.5 kPa. The second range of selectable baseline pressures may be between 1 kPa and 3 kPa.

It may be contemplated that a first time limit for applying the pressure pulses for the first respiratory ailment may be different than a second time limit for applying the pressure pulses for the second respiratory ailment. A first frequency of the pressure pulses for the first respiratory ailment may be different than a second frequency of the pressure pulses for the second respiratory ailment. The first frequency may be greater than the second frequency. The second frequency may be greater than the first frequency.

According to another aspect of the disclosed embodiments, a high frequency chest wall oscillation apparatus may include a housing. An air pulse generator may be carried by the housing. Circuitry may be carried by the housing and may be configured to control the air pulse generator. A control panel may be carried by the housing and may be coupled to the circuitry. The control panel may permit a user to select first and second respiratory ailments to be treated by application of pressure pulses from the air pulse generator to a chest of a patient. A first frequency of the pressure pulses for the first respiratory ailment may be different than a second frequency of the pressure pulses for the second respiratory ailment.

In some embodiments, the first frequency may be greater than the second frequency. The second frequency may be greater than the first frequency.

Optionally, a maximum baseline pressure of a first range of selectable baseline pressures of the pressure pulses for the first respiratory ailment may be greater than a maximum baseline pressure of a second range of selectable baseline pressures of the pressure pulses for the second respiratory ailment. A minimum baseline pressure of a first range of selectable baseline pressures of the pressure pulses for the first respiratory ailment may be greater than a minimum baseline pressure of a second range of selectable baseline pressures of the pressure pulses for the second respiratory ailment. A mean baseline pressure of the first range of selectable baseline pressures may be more than half of a mean baseline pressure of the second range of selectable baseline pressures. The mean baseline pressure of the first range of selectable baseline pressures may be at least one kPA greater than the mean baseline pressure of the second range of selectable baseline pressures. The first range of selectable baseline pressures may be between 2 kPa and 4.5 kPa. The second range of selectable baseline pressures may be between 1 kPa and 3 kPa.

In some embodiments, the first respiratory ailment may be cystic fibrosis. The second respiratory ailment may be one of bronchiectasis or a neuromuscular ailment. It may be contemplated that a first time limit for applying the pressure pulses for the first respiratory ailment may be different than a second time limit for applying the pressure pulses for the second respiratory ailment. The first time limit may be greater than the second time limit. The second time limit may be greater than the first time limit.

It may be desired that the circuitry controls the air pulse generator by transmitting a current to the air pulse generator. The current may be adjustable to adjust an intensity of the pressure pulses from the air pulse generator.

According to yet another aspect of the disclosed embodiments, a high frequency chest wall oscillation apparatus may include a garment configured to be positioned over a chest of a patient. An air pulse generator may be pneumatically coupled to the garment. Circuitry may be carried by the garment and may be configured to control the air pulse generator. A control panel may be carried by the housing and may be coupled to the circuitry. The control panel may permit a user to select first and second respiratory ailments to be treated by application of pressure pulses from the air pulse generator to the chest of the patient. A first range of selectable baseline pressures of the pressure pulses for the first respiratory ailment may be different than a second range of selectable baseline pressures of the pressure pulses for the second respiratory ailment.

In some embodiments, the control panel may include a display screen with selectable buttons adjacent to the display screen. The control panel may include a touchscreen display.

It may be desired that the first respiratory ailment may be cystic fibrosis. The second respiratory ailment may be one of bronchiectasis or a neuromuscular ailment.

Optionally, the first range of selectable baseline pressures may have a maximum baseline pressure greater than a maximum baseline pressure of the second range of selectable baseline pressures. The first range of selectable baseline pressures may have a minimum baseline pressure greater than a minimum baseline pressure of the second range of selectable baseline pressures. A mean baseline pressure of the first range of selectable baseline pressures may be more than half of a mean baseline pressure of the second range of selectable baseline pressures. The mean baseline pressure of the first range of selectable baseline pressures may be at least one kPA greater than the mean baseline pressure of the second range of selectable baseline pressures. The first range of selectable baseline pressures may be between 2 kPa and 4.5 kPa. The second range of selectable baseline pressures may be between 1 kPa and 3 kPa.

It may be contemplated that a first time limit for applying the pressure pulses for the first respiratory ailment may be different than a second time limit for applying the pressure pulses for the second respiratory ailment. A first frequency of the pressure pulses for the first respiratory ailment may be different than a second frequency of the pressure pulses for the second respiratory ailment. The first frequency may be greater than the second frequency. The second frequency may be greater than the first frequency.

According to a further aspect of the disclosed embodiments, a high frequency chest wall oscillation apparatus may include a housing. An air pulse generator may be carried by the housing. Circuitry may be carried by the housing and may be configured to control the air pulse generator. A control panel may be carried by the housing and may be coupled to the circuitry. The control panel may permit a user to select first, second, and third respiratory ailments to be treated by application of pressure pulses from the air pulse generator to a chest of a patient. A first range of selectable baseline pressures of the pressure pulses for the first respiratory ailment may be different than a second range of selectable baseline pressures of the pressure pulses for the second respiratory ailment. A third range of selectable baseline pressures of the pressure pulses for the third respiratory ailment may be different than the first range of selectable baseline pressures of the pressure pulses. The second range of selectable baseline pressures of the pressure pulses may be the same as the third range of selectable baseline pressures of the pressure pulses.

In some embodiments, the control panel may include a display screen with selectable buttons adjacent to the display screen. The control panel may include a touchscreen display.

Optionally, the first respiratory ailment may be cystic fibrosis. The second respiratory ailment may be bronchiectasis. The third respiratory ailment may be a neuromuscular ailment.

It may be desired that the first range of selectable baseline pressures may have a maximum baseline pressure greater than a maximum baseline pressure of at least one of the second range of selectable baseline pressures and the third range of selectable baseline pressures. The first range of selectable baseline pressures may have a minimum baseline pressure greater than a minimum baseline pressure of at least one of the second range of selectable baseline pressures and the third range of selectable baseline pressures. A mean baseline pressure of the first range of selectable baseline pressures may be more than half of a mean baseline pressure of at least one of the second range of selectable baseline pressures and the third range of selectable baseline pressures. The mean baseline pressure of the first range of selectable baseline pressures may be at least one kPA greater than the mean baseline pressure of at least one of the second range of selectable baseline pressures and the third range of selectable baseline pressures. The first range of selectable baseline pressures may be between 2 kPa and 4.5 kPa. The second range of selectable baseline pressures may be between 1 kPa and 3 kPa. The third range of selectable baseline pressures may be between 1 kPa and 3 kPa. A first frequency of the pressure pulses for the first respiratory ailment may be different than at least one of a second frequency of the pressure pulses for the second respiratory ailment and a third frequency of the pressure pulses for the third respiratory ailment.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective of an HFCWO system in accordance with the disclosed embodiments and having a vest attached to an HFCWO apparatus with tubing;

FIG. 2 is a perspective view of the HFCWO apparatus shown in FIG. 1;

FIG. 3 is a schematic diagram of the circuitry of the HFCWO apparatus shown in FIG. 2;

FIG. 4 is a screen shot of a display screen showing a program mode of the HFCWO apparatus;

FIG. 5 is a screen shot of a display screen showing an intensity selector of the HFCWO apparatus;

FIG. 6 is a screen shot of a display screen showing a frequency selector of the HFCWO apparatus;

FIG. 7 is a screen shot of a display screen showing a time limit selector of the HFCWO apparatus; and

FIG. 8 is a chart illustrating pressure ranges for different treatment modes of the HFCWO therapy system.

### DETAILED DESCRIPTION

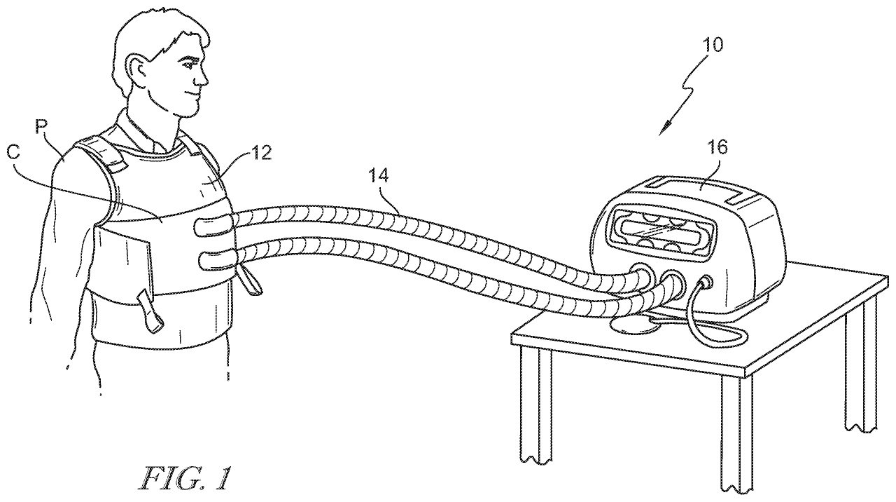

FIG. 1 shows a pneumatic HFCWO system 10 according to the present disclosure. FIG. 1 shows patient P having chest C and system 10 which includes an inflatable garment 12, hoses 14, and a HFCWO apparatus 16. In the illustrative embodiment, the garment 12 is a vest. Garment 12 is positioned on chest C of patient P. Hoses 14 are fluidly connected to garment 12 and HFCWO apparatus 16.

In operation, HFCWO apparatus 16 provides air pulses and a baseline pressure to garment 12. The air pulses oscillate garment 12, while the baseline pressure keeps garment 12 inflated. Garment 12 applies an oscillating compressive force to chest C of patient P. Thus, system 10 produces HFCWO to clear mucous or induce deep sputum from the lungs of patient P.

HFCWO apparatus 16 produces a pressure having a steady state air pressure component (or “baseline pressure”) and an oscillating air pressure component. The pressure is a resulting composite waveform of the oscillating air pressure component and the steady state air pressure component. The oscillating air pressure component is substantially comprised of air pulses, while the steady state air pressure component is substantially comprised of baseline pressure.

The force generated on the chest C by garment 12 has an oscillatory force component and a steady state force component. The steady state force component corresponds to the steady state air pressure component, and the oscillating force component corresponds to the oscillating air pressure component. In a preferred embodiment, the steady state air pressure is greater than atmospheric pressure with the oscillatory air pressure riding on the steady state air pressure. With this embodiment, the resulting composite waveform provides an entire oscillation cycle of garment 12 that is effective at moving chest C of patient P, because there is no point at which pressure applied to chest C by garment 12 is below atmospheric pressure. Chest movement is induced by apparatus 16 via garment 12 due to garment 12 having an effective pressure (i.e. greater than atmospheric pressure) on chest C.

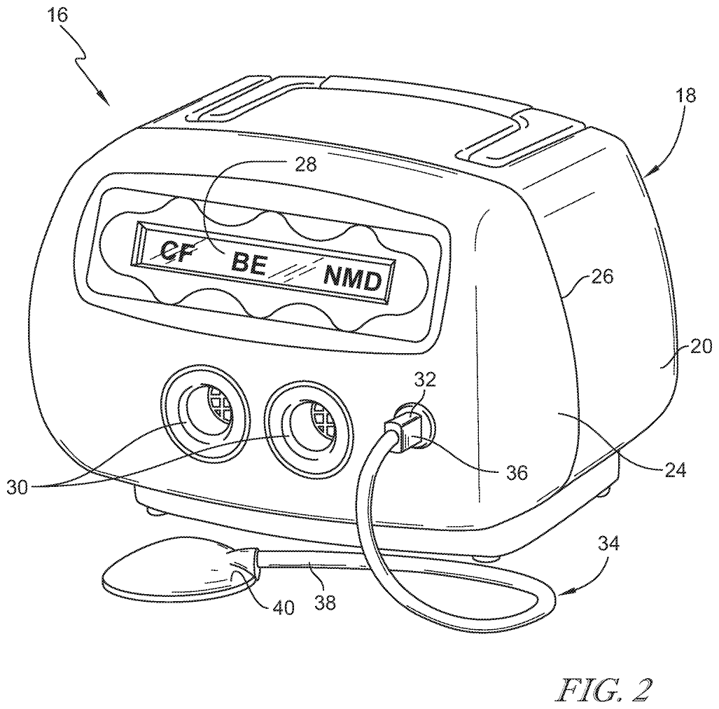

FIG. 2 shows one embodiment of HFCWO apparatus 16. HFCWO apparatus 16 includes shell or housing 18 having a back portion 20 with a handle 22, a front portion 24 and a seam 26. Front portion 24 further includes a user interface 28, air openings 30, a switch port 32 and a control switch 34 having a connection plug 36, a tube 38 and a control bulb 40. Handle 22 is connected on back portion 20 of shell 18. Front portion 24 is removably connected to back portion 20 along seam 26. Connection plug 36 connects to front portion 24 via switch port 32, and connection plug 36 fluidly connects to control bulb 40 via tube 38. Bulb 40 is pressed, such as by a patient's foot, to sequentially turn apparatus 16 on and off.

In operation, user interface 28 allows patient P to control operating parameters of HFCWO apparatus 16. Air openings 30 connect hoses 14 to generator 16. Switch port 32 allows connection plug 36 to connect to HFCWO apparatus 16. Patient P controls activation/deactivation of HFCWO apparatus 16 through control switch 34.

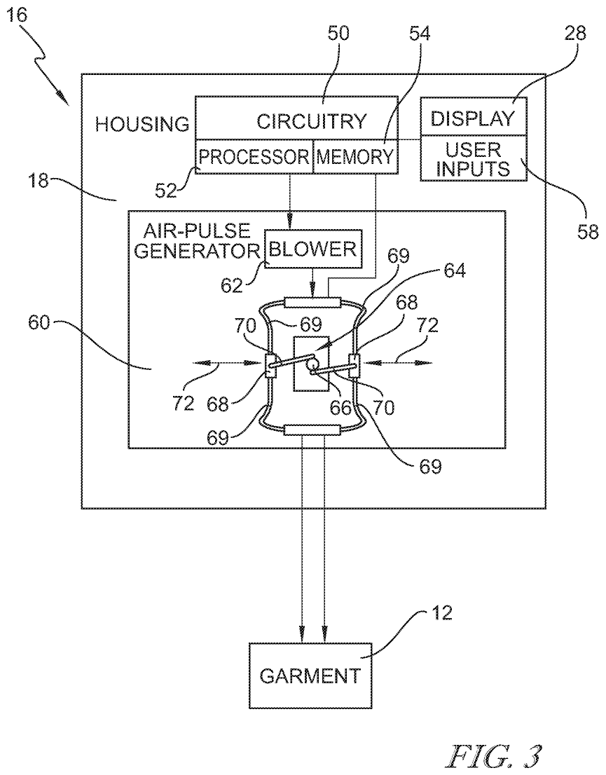

Referring now to FIG. 3, the HFCWO apparatus 16 includes circuitry 50 carried by the housing 18. The circuitry 50 includes a processor 52, for example a microprocessor, and a memory 54. The memory 54 retains instructions that are carried out by the processor 52 to operate the HFCWO apparatus 16 as described herein. The circuitry 50 may be embodied as any device or circuitry (e.g., a processor, a microcontroller, a field programmable gate array (FPGA), an application specific integrated circuit (ASIC), reconfigurable circuitry, System on Chip (SoC), Programmable System on Chip (PSoC), Computer on Module (CoM), and System on Module (SoM), etc.) and/or software configured to operate the HFCWO apparatus 16 as described herein. The user interface 28 having a plurality of user inputs 58 is electronically coupled to the circuitry 50 to allow the user to operate the HFCWO apparatus 16. The circuitry 50 is configured to operate an air-pulse generator 60 that supplies pulses of air to the garment 12.

The air pulse generator 60 is carried by the housing 18 and includes a blower 62 configured to supply air to the garment 12. A motor 64 oscillates the air from the blower 62 as it is delivered to the garment 12. The motor 64 includes a rotor 66 that rotates to oscillate a pair of diaphragm plates 68 that are coupled to respective diaphragms or membranes 69 which are made of resilient material such as rubber. An arm 70 is coupled between each diaphragm plate 68 and the rotor 66. As the rotor 66 rotates the arms 70 reciprocate back and forth in the direction of arrows 72 to oscillate the diaphragm plates 68. The oscillating diaphragm plates 68 and diaphragms 69 act on the airflow from the blower 62 to pulsate the air supplied to the garment 12. As described in more detail below, the air pulses are controlled with the user inputs 58 to provide a desired treatment to the patient based on an operating mode of the HFCWO apparatus 16.

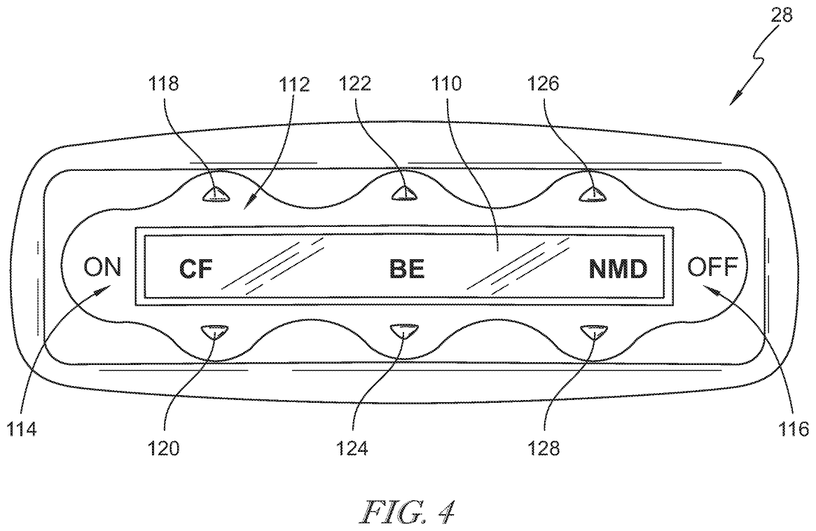

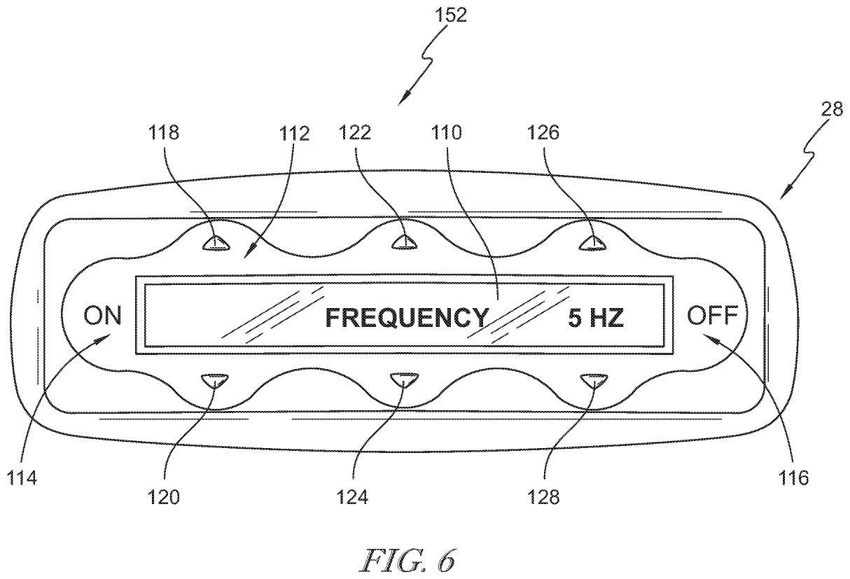

Although the illustrative air pulse generator 60 uses reciprocating diaphragms 69 to generate oscillatory air pulses, other types of air pulse generators are used in other embodiments. For example, reciprocating pistons create air pulses in some embodiments. See, for example, FIG. 28 and the related description in U.S. Pat. No. 9,572,743 which is hereby incorporated by reference herein. U.S. Pat. No. 9,572,743 discloses air pulses created by a rotary valve in FIGS. 13-21 and by a flapper valve in FIGS. 22-24. Thus, these structures are used in alternative embodiment air pulse generators according to the present disclosure. Other air pulse generator embodiments contemplated by this disclosure include a pneumatically piloted self-oscillating valve like that disclosed in FIG. 4 of U.S. Pat. No. 8,460,223; a rotary plate valve like that disclosed in FIGS. 6-16, 41-46, and 72 of U.S. Patent Application Publication No. 2018/0085541 A1; and a rotary spool valve like that disclosed in FIGS. 17-21 of U.S. Patent Application Publication No. 2018/0085541 A1. U.S. Pat. No. 8,460,223 and U.S. Patent Application Publication No. 2018/0085541 A1 are hereby incorporated by reference herein.

User interface 28 is shown in more detail in FIG. 4. User interface 28 includes display panel 110 and keypad 112 having the following user inputs 58: ON button 114, OFF button 116, UL (Upper Left) 118, LL (Lower Left) 120, UM (Upper Middle) 122, LM (Lower Middle) 124, UR (Upper Right) 126 and LR (Lower Right) 128.

Display panel 110 is preferably an LCD panel display, although other displays, such as LED, could also be used. Display panel 110 shows the status of HFCWO apparatus 16 and options available for usage. In some embodiments, display panel 110 is a touch screen display and user inputs 58, such as buttons 114, 116, 118, 120, 122, 124, 126, and 128 are shown on the touchscreen display and are selectable by the user to control apparatus 16 as described herein with regard to the same buttons on keypad 112.

Keypad 112 is preferably an elastomeric or rubber eight button keypad that surrounds display panel 110. ON button 114 is located on the left side of display panel 110, and OFF button 116 is located on the right side of display panel 110. UL 118, UM 122 and UR 126 are located along the top of display panel 110, and LL 120, LM 124 and LR 128 are located along the bottom of display panel 110.

Patient P may modify operation of HFCWO apparatus 16. HFCWO apparatus 16 also provides feedback to patient P as to its status. The messages are displayed as text on display panel 110.

The function of UL 118, LL 120, UM 122, LM 124, UR 126 and LR 128 varies depending on the current mode of HFCWO apparatus 16. Each button is programmed to control various functions including the frequency of the oscillating air pressure component, or air pulses, the steady state air pressure component, or baseline pressure, and a timer, which deactivates HFCWO apparatus 16 automatically at the end of a therapy session and will be more fully described below.

In the illustrative embodiment, the pressure of the pressurized air supplied to the garment 12 is dictated by a mode selected. The mode is selected based on a condition of the patient. For example, in the illustrative embodiment, the system 100 is configured to treat patients having one of cystic fibrosis (CF), bronchiectasis (BE), or a neuromuscular ailment (NMD). Each of these conditions may be treated using a separate mode of the system 100. In some embodiments, more than one condition may be treated with the same mode. For example, bronchiectasis and a neuromuscular ailment may be treated by one mode, while cystic fibrosis is treated with another mode.

As shown in FIG. 4, the buttons UL 118, LL 120, UM 122, LM 124, UR 126 and LR 128 are utilized to select a treatment mode for the patient. For example, by selecting UL 118 or LL 120, the cystic fibrosis (CF) mode is selected to treat a patient with cystic fibrosis. By selecting UM 122 or LM 124, the bronchiectasis (BE) mode is selected to treat a patient with bronchiectasis. By selecting UR 126 or LR 128, the neuromuscular ailment (NMD) mode is selected to treat a patient with a neuromuscular ailment. In some embodiments, the BE mode and the NMD mode may be selected using the same buttons. It will be appreciated that the HFCWO apparatus 16 may be configured to treat ailments other than those listed herein. Additionally, the user interface 28 may be configured with additional buttons to accommodate additional modes. In other embodiments, at least one of the buttons UL 118, LL 120, UM 122, LM 124, UR 126 and LR 128 may be used to toggle to a second screen that lists additional modes. In yet another embodiment, the user interface 28 may include two lines of text. In such an embodiment, the buttons UL 118, UM 122, and UR 126 may be utilized to select modes listed in the top line of text, and the buttons LL 120, LM 124, and LR 128 may be utilized to select modes in the bottom line of text.

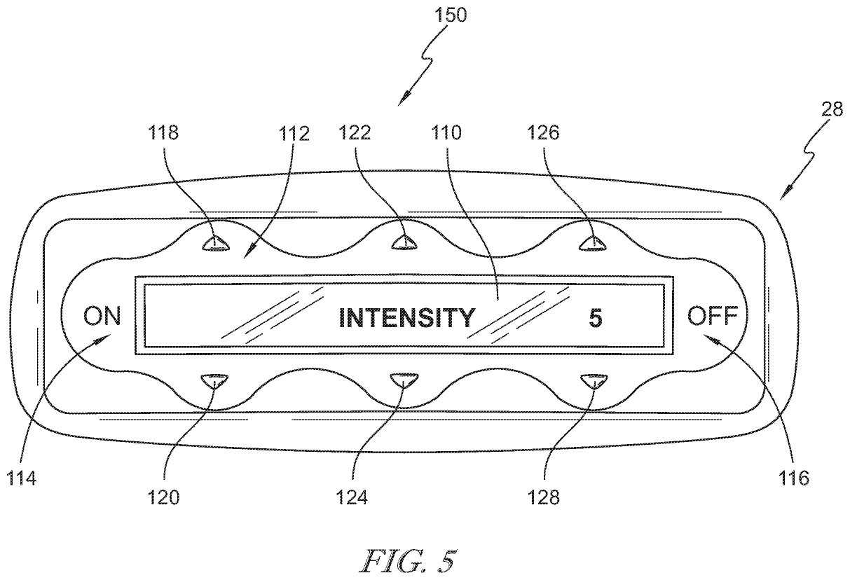

Once a mode is selected, an intensity screen 150 is used to select an intensity of the mode, as shown in FIG. 5. For example, buttons UR 126 and LR 128 are used to toggle the intensity within a range of 1-10. The button UR 126 increases the intensity, and the button LR 128 decreases the intensity. The selected intensity is displayed on the display panel 110. For example, the intensity “5” is displayed in FIG. 5. By increasing the intensity, the baseline pressure applied to the garment 12 is increased in each mode. By decreasing the intensity, the baseline pressure applied to the garment 12 is decreased in each mode. It should be noted that any number of intensities may be provided, e.g. 1-5 or 1-20. Additionally, while buttons UR 126 and LR 128 are illustrated to toggle the intensity, any combination of the buttons UL 118, LL 120, UM 122, LM 124, UR 126 and LR 128 may be utilized to toggle the intensity, in some embodiments.

A frequency screen 152 is used to select a frequency of the mode, as shown in FIG. 6. In one embodiment, the frequency for each mode may be adjustable to be from about 0 Hertz (Hz) to about 20 Hz. The buttons UR 126 and LR 128 are used to toggle the frequency within this range. The button UR 126 increases the frequency, and the button LR 128 decreases the frequency. The selected frequency is displayed on the display panel 110. For example, the frequency “5 Hz” is displayed in FIG. 6. By increasing the frequency, the frequency of the oscillations of the pressure applied to the garment 12 is increased in each mode. By decreasing the frequency, the frequency of the oscillations of the pressure applied to the garment 12 is decreased in each mode. It should be noted that any range of frequency may be provided. Additionally, while buttons UR 126 and LR 128 are illustrated to toggle the frequency, any combination of the buttons UL 118, LL 120, UM 122, LM 124, UR 126 and LR 128 may be utilized to toggle the frequency, in some embodiments.

In some embodiments, each treatment mode has a preselected frequency. For example, the CF mode may have a preselected first frequency, the BE mode may a preselected second frequency, and the NMD mode may have a preselected third frequency. In some embodiments, at least two of the first frequency, the second frequency, and the third frequency are the same. At least one of the second frequency and third frequency may be greater than the first frequency. Alternatively, at least one of the second frequency and the third frequency may be less than the first frequency. Moreover, the third frequency may be greater or less than the second frequency.

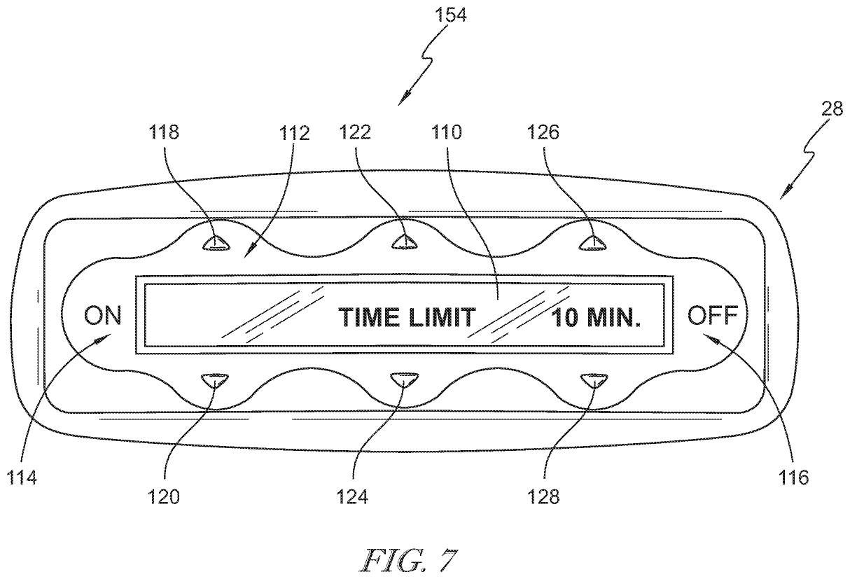

A time limit screen 154 is used to select a time limit of the mode, as shown in FIG. 7. In one embodiment, the time limit for each mode may be adjustable to be from about 0 minutes to 60 minutes. The buttons UR 126 and LR 128 are used to toggle the time limit within this range. The button UR 126 increases the time limit, and the button LR 128 decreases the time limit. The selected time limit is displayed on the display panel 110. For example, the time limit “10 Min.” is displayed in FIG. 7. By increasing the time limit, the time that the oscillatory pressure applied to the garment 12 is increased in each mode. By decreasing the time limit, the time that the oscillatory pressure applied to the garment 12 is decreased in each mode. It should be noted that any range of time limit may be provided. Additionally, while buttons UR 126 and LR 128 are illustrated to toggle the time limit, any combination of the buttons UL 118, LL 120, UM 122, LM 124, UR 126 and LR 128 may be utilized to toggle the time limit, in some embodiments.

In some embodiments, each treatment mode has a preselected time limit. For example, the CF mode may have a preselected first time limit, the BE mode may a preselected second time limit, and the NMD mode may have a preselected third time limit. In some embodiments, at least two of the first time limit, the second time limit, and the third time limit are the same. At least one of the second time limit and third time limit may be greater than the first time limit. Alternatively, at least one of the second time limit and the third time limit may be less than the first time limit. Moreover, the third time limit may be greater or less than the second time limit.

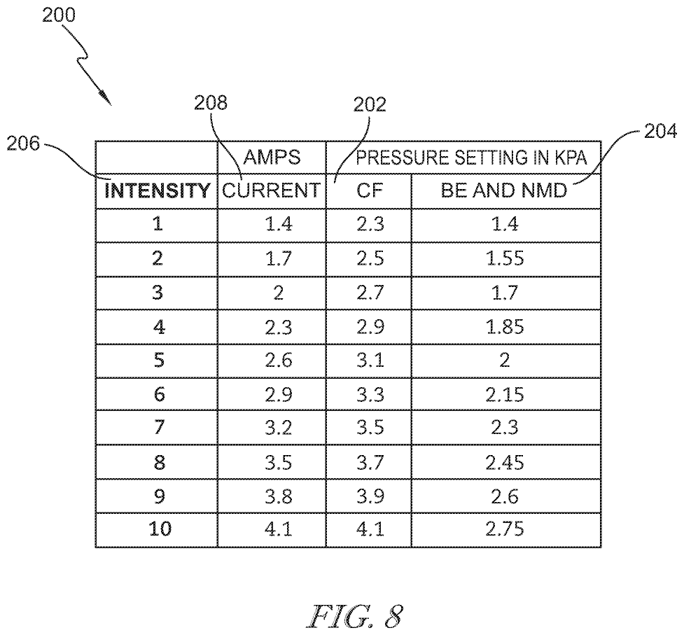

Referring now to FIG. 8, a chart 200 illustrating baseline pressure ranges for different treatment modes of the HFCWO therapy system 100 is provided. In the illustrative embodiment, the system 100 includes two treatment modes, a CF treatment mode 202 and a BE/NMD treatment mode 204. It should be appreciated that in some embodiments, the BE treatment mode and the NMD treatment mode may be different and each have a different range of baseline pressures for treatment. Each treatment mode 202, 204 includes a range of baseline pressures depending on the intensity selected. The intensity 206 is based on a current 208 provided by the system 100 to blower 62. In the illustrative embodiment, the current 208 is within a range of 1.4 Amps to 4.1 Amps. It should be noted that other current ranges may be utilized. For example, the current 208 may be within a range of 1 Amp to 5 Amps.

The baseline pressure range for the CF treatment mode 202 is illustrated as being between 2.3 kPA and 4.1 kPa. Notably, a broader range may be contemplated. For example, the baseline pressure range for the CF treatment mode 202 may be between 2 kPa and 4.5 kPa. Illustratively, for a first intensity of the CF treatment mode 202, the baseline pressure is 2.3 kPa; for a second intensity, the baseline pressure is 2.5 kPa; for a third intensity, the baseline pressure is 2.7 kPa; for a fourth intensity, the baseline pressure is 2.9 kPa; for a fifth intensity, the baseline pressure is 3.1 kPa; for a sixth intensity, the baseline pressure is 3.3 kPa; for a seventh intensity, the baseline pressure is 3.5 kPa; for an eighth intensity, the baseline pressure is 3.7 kPa; for a ninth intensity, the baseline pressure is 3.9 kPa; and for a tenth intensity, the baseline pressure is 4.1 kPa.

The baseline pressure range for the BE/NMD treatment mode 204 is illustrated as being between 1.4 kPA and 2.75 kPa. Notably, a broader range may be contemplated. For example, the baseline pressure range for the BE/NMD treatment mode 204 may be between 1 kPa and 3 kPa. Illustratively, for a first intensity of the BE/NMD treatment mode 204, the baseline pressure is 1.4 kPa; for a second intensity, the baseline pressure is 1.55 kPa; for a third intensity, the baseline pressure is 1.7 kPa; for a fourth intensity, the baseline pressure is 1.85 kPa; for a fifth intensity, the baseline pressure is 2 kPa; for a sixth intensity, the baseline pressure is 2.15 kPa; for a seventh intensity, the baseline pressure is 2.3 kPa; for an eighth intensity, the baseline pressure is 2.45 kPa; for a ninth intensity, the baseline pressure is 2.6 kPa; and for a tenth intensity, the baseline pressure is 2.75 kPa.

In the illustrative embodiment, the CF treatment mode 202 has a minimum baseline pressure that is greater than the minimum baseline pressure of the BE/NMD treatment mode 204. The CF treatment mode 202 also has a maximum baseline pressure that is greater than a maximum baseline pressure of the BE/NMD treatment mode. A mean baseline pressure of the CF treatment mode 202 is greater than a mean baseline pressure of the BE/NMD treatment mode 204. Also, the mean baseline pressure of the CF treatment 202 mode is at least 1 kPa greater than the mean baseline pressure of the BE/NMD treatment mode 204.

Although this disclosure refers to multiple embodiments, it will be appreciated that aspects of each embodiment may be utilized with other embodiments described herein.

1. A high frequency chest wall oscillation apparatus comprising
a housing,
an air pulse generator carried by the housing,
circuitry carried by the housing and configured to control the air pulse generator, and
a control panel carried by the housing and coupled to the circuitry, the control panel permitting a user to select first and second respiratory ailments to be treated by application of pressure pulses from the air pulse generator to a chest of a patient, a first range of selectable baseline pressures of the pressure pulses for the first respiratory ailment being different than a second range of selectable baseline pressures of the pressure pulses for the second respiratory ailment.

2. The apparatus of claim 1, wherein the control panel comprises a display screen with selectable buttons adjacent to the display screen.

3. The apparatus of claim 1, wherein the control panel comprises a touchscreen display.

4. The apparatus of claim 1, wherein the first respiratory ailment is cystic fibrosis.

5. The apparatus of claim 4, wherein the second respiratory ailment is one of bronchiectasis or a neuromuscular ailment.

6. The apparatus of claim 1, wherein the first range of selectable baseline pressures has a maximum baseline pressure greater than a maximum baseline pressure of the second range of selectable baseline pressures.

7. The apparatus of claim 6, wherein the first range of selectable baseline pressures has a minimum baseline pressure greater than a minimum baseline pressure of the second range of selectable baseline pressures.

8. The apparatus of claim 1, wherein a mean baseline pressure of the first range of selectable baseline pressures is more than half of a mean baseline pressure of the second range of selectable baseline pressures.

9. The apparatus of claim 8, wherein the mean baseline pressure of the first range of selectable baseline pressures is at least one kPA greater than the mean baseline pressure of the second range of selectable baseline pressures.

10. The apparatus of claim 1, wherein the first range of selectable baseline pressures is between 2 kPa and 4.5 kPa.

11. The apparatus of claim 10, wherein the second range of selectable baseline pressures is between 1 kPa and 3 kPa.

12. The apparatus of claim 1, wherein a first time limit for applying the pressure pulses for the first respiratory ailment is different than a second time limit for applying the pressure pulses for the second respiratory ailment.

13. The apparatus of claim 1, wherein a first frequency of the pressure pulses for the first respiratory ailment is different than a second frequency of the pressure pulses for the second respiratory ailment.

14. The apparatus of claim 13, wherein the first frequency is greater than the second frequency.

15. The apparatus of claim 13, wherein the second frequency is greater than the first frequency.

16. A high frequency chest wall oscillation apparatus comprising a housing,
an air pulse generator carried by the housing,
circuitry carried by the housing and configured to control the air pulse generator, and
a control panel carried by the housing and coupled to the circuitry, the control panel permitting a user to select first and second respiratory ailments to be treated by application of pressure pulses from the air pulse generator to a chest of a patient, wherein a first frequency of the pressure pulses for the first respiratory ailment is different than a second frequency of the pressure pulses for the second respiratory ailment.

17. The apparatus of claim 16, wherein a maximum baseline pressure of a first range of selectable baseline pressures of the pressure pulses for the first respiratory ailment is greater than a maximum baseline pressure of a second range of selectable baseline pressures of the pressure pulses for the second respiratory ailment.

18. The apparatus of claim 17, wherein a minimum baseline pressure of a first range of selectable baseline pressures of the pressure pulses for the first respiratory ailment is greater than a minimum baseline pressure of a second range of selectable baseline pressures of the pressure pulses for the second respiratory ailment.

19. The apparatus of claim 17, wherein a mean baseline pressure of the first range of selectable baseline pressures is more than half of a mean baseline pressure of the second range of selectable baseline pressures.

20. The apparatus of claim 19, wherein the mean baseline pressure of the first range of selectable baseline pressures is at least one kPA greater than the mean baseline pressure of the second range of selectable baseline pressures.

21. The apparatus of claim 17, wherein:
the first range of selectable baseline pressures is between 2 kPa and 4.5 kPa, and
the second range of selectable baseline pressures is between 1 kPa and 3 kPa.

22. The apparatus of claim 16, wherein:
the first respiratory ailment is cystic fibrosis, and
the second respiratory ailment is one of bronchiectasis or a neuromuscular ailment.

23. The apparatus of claim 16, wherein a first time limit for applying the pressure pulses for the first respiratory ailment is different than a second time limit for applying the pressure pulses for the second respiratory ailment.

24. The apparatus of claim 16, wherein the circuitry controls the air pulse generator by transmitting a current to the air pulse generator, wherein the current is adjustable to adjust an intensity of the pressure pulses from the air pulse generator.
